(19) United States
(12) Patent Application Publication
(10) Pub. No.: US 2022/0012757 A1
(43) Pub. Date: Jan. 13, 2022

(54) METHOD AND SYSTEM FOR AUTOMATED AGGREGATION OF CARBON OFFSETS

(71) Applicants: COLE WALKER, Huntsville, AL (US); JASON MARTIN, Huntsville, AL (US)

(72) Inventors: COLE WALKER, Huntsville, AL (US); JASON MARTIN, Huntsville, AL (US)

(21) Appl. No.: 16/362,776

(22) Filed: Mar. 25, 2019

(51) Int. Cl. G06Q 30/02; G06Q 30/00; G06Q 10/06

(52) U.S. Cl. CPC G06Q 30/0208; G06Q 10/06375; G06Q 30/018

(57) ABSTRACT

A method for accounting for carbon offsets realized by energy-efficient, electrically-powered devices used by electrical power consumers includes obtaining power usage data for the devices, calculating an initial power reduction attributable to the device, calculating a final power reduction accounting for line loss between the device's location and the location of the power generator. The final power reduction is converted to a carbon offset amount by considering the fuel type used by the power generator. Carbon offsets are then accounted for with distributed ledger technology. A system that performs the method is also disclosed.

### BACKGROUND

Field

The present disclosure relates generally to accounting for carbon offsets realized by energy-efficient electrical devices, and more particularly to a system for automatically aggregated and validating carbon offsets realized by energy-efficient electrical devices.

### Description of the Problem and Related Art

The burning of fossil fuels as a primary source of electricity is a major driver for the release of greenhouse gases (“GHG”) into the atmosphere. It is widely agreed that the increased GHG are key factors in climate change. Therefore, in an effort to reduce the amount of GHG there is a significant worldwide focus on reducing the amount of electricity being used to operate every type of business and building where people work, live and play. Including items such as: computers, peripherals, routers, networking equipment, lighting, heating and ventilation pumps, fans, motors, air conditioning equipment, Internet of Things hardware, software and communications networks.

Leading corporations, governments and institutions have recognized the importance of the worldwide climate change and have been attempting to reduce GHG through as many approaches as possible but to date have had limited success. Many have begun to place an expense on the impact GHG will have on their businesses. Over 45 national government bodies have placed a cost on carbon which is the main GHG that is tracked. It has created a marketplace for the trading of carbon credits or offsets that are created through a variety of means including energy reduction efforts.

The biggest challenge for worldwide adoption of GHG/Carbon reducing behaviors such as energy efficiency has not been public awareness about climate change but incentives or rewards at the individual, company or institutional level that can easily be earned for the behavior that needs to be encouraged. Currently it is not easy for anyone to easily understand how much Carbon is reduced through daily behaviors such as energy efficiency measures.

People understand that using less energy is generally good for reducing electricity and thus reducing GHG. However, it has been very difficult to know what your direct impact was from the changed behavior or modified use of an energy consuming device. In order to get that reward you must be able to measure and manage what you are trying to accomplish. In short what gets rewarded gets done therefore to succeed people must be rewarded for easily accomplished changes.

Prior attempts to collect redeemable carbon credits have been disclosed in the art, particularly in U.S. Pat. No. 9,665,907 to Hamilton II, et al.

Therefore, what is needed is a system or method for easily measuring and rewarding behaviors that reduce GHG/Carbon. Carbon credit aggregation system allows for an easily managed carbon credit aggregation across many devices by interacting with a variety of hardware, software and databases to accurately measure and validate carbon reductions which can be sold and thus rewarding the behavior of GHG/Carbon reduction. In addition to providing accuracy for calculation of power savings for the purpose of credit or offset generation, this system also provides means for verification of the authenticity and provenance for the credits or offsets, providing the trust required for widespread adoption and utilization.

### SUMMARY

For purposes of summary, certain aspects, advantages, and novel features are described herein. It is to be understood that not necessarily all such advantages may be achieved in accordance with any one particular embodiment. Thus, the apparatuses or methods claimed may be embodied or carried out in a manner that achieves or optimizes one advantage or group of advantages as taught herein without necessarily achieving other advantages as may be taught or suggested herein.

In one aspect, a method is set forth for accounting for carbon offsets realized by energy-efficient, electrically-powered devices used by electrical power consumers includes obtaining power usage data for the devices, calculating an initial power reduction attributable to the device, calculating a final power reduction accounting for line loss between the device's location and the location of the power generator. The final power reduction is converted to a carbon offset amount by considering the fuel type used by the power generator. Carbon offsets are then accounted for with distributed ledger technology.

Another aspect is found in a system for automatically aggregated carbon offsets realized through the use of energy efficient devices. The system can comprise a one or more energy efficient devices that are associated with energy reduction measurement devices. The measurement devices communicate energy reduction data to a computer-based system for automatically aggregating the energy reduction amounts represented by the data, converting such amounts to a carbon offset value, and generating a carbon offset token.

### BRIEF DESCRIPTION OF THE DRAWINGS

The apparatus/system/method is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a first embodiment of a system for automated aggregation of carbon offsets;

FIG. 2A is a functional diagram of an exemplary database stored in a computer-based automated carbon reduction aggregation system;

FIG. 2B is a functional diagram of exemplary control logic used in one embodiment of a computer-based automated carbon reduction aggregation system;

FIG. 3 is a functional diagram of an exemplary computer-based system;

FIG. 4 is a flowchart depicting an exemplary process performed by an automated carbon reduction aggregation system;

FIG. 5 is an exemplary token in message format;

FIG. 6A presents one example of distributing carbon reduction tokens via a distributed ledger;

FIG. 6B illustrates another example of distributing carbon micro offsets via a distributed ledger; and

FIG. 7 is a flowchart depicting a process for distributing micro offsets via distributed ledger.

### DETAILED DESCRIPTION

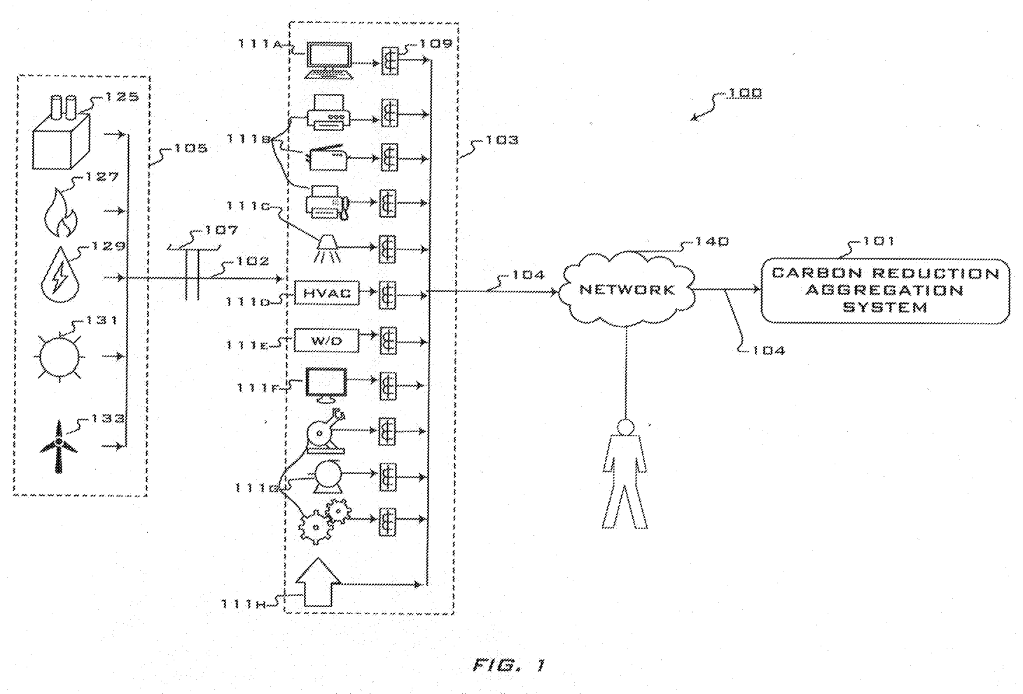

The various embodiments of the system and method and their advantages are best understood by referring to FIGS. 1 through 7 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

FIG. 1 depicts a topology of an exemplary power generation and data flow system 100 in which an exemplary carbon reduction aggregation system may be deployed. Electrical power generators 105 include coal plants 125, natural gas producers 127, hydroelectric plants 129, solar power plants 131, wind turbines 133. Each of these power generators 105 generate and transmit electricity through electrical distribution grid 107 along transmission lines 102, and, by virtue of their respective production activities, create a measurable CO₂ increase. The amount of CO₂ generation is typically dependent upon the type of fuel used to generate power. Table I below lists the CO₂ amounts in kg per kilowatt-hour (“KwH”) per energy generation fuel. Distribution grid 107 comprises high transmission lines, transformers, transmission and distribution substations, and batteries.

TABLE 1
CO₂ in kg per KwH by fuel type used for energy generation.
Estimated kg of CO2 per kWh

| | |
|---|---|
| Natural Gas | 0.200 |
| LPG | 0.230 |
| Refinery Gas | 0.240 |
| Gasoline | 0.250 |
| Kerosene | 0.260 |
| Diesel | 0.270 |
| Crude Oil | 0.260 |
| Fuel Oil | 0.280 |
| Hard Coal | 0.340 |
| Lignite | 0.360 |

Electrical power consumers, designated generally by group 103, include residential consumers with electricity consuming devices such as computers 111a, computer peripherals 111b, lights 111c, heating and cooling systems 111d, appliances 111e (e.g., washer/dryer, oven, refrigerator, etc.), and entertainment devices 111f. Commercial and industrial consuming devices may include not only the above listed devices but also heavy mechanical machines 111g. Such consuming devices receive electrical power along transmission line 102 via distribution network 107. In this embodiment 100, each device is associated with a measuring device 109 which measures electrical power consumed. In preferable embodiments, each device or group of devices are associated with a measuring device 109 that is adapted to measure the amount of electrical power saved as a result of using an energy efficient consuming device 111a-h. One example of such a measuring device 109 is a current transformer. Measuring device 109 generates device data which are transmitted over data lines 104 and provided via network 140, to carbon reduction aggregation system 101. It will be appreciated that power consumption may be calculated per device or per structure in which a group of power-consuming devices are located. For example, power consumption may be calculated for an entire residential or commercial building.

In some embodiments, consuming device 111a-111g may be a so-called “smart device” with built-in computer-based processors configured with network communication devices all accessing a common network. e.g., the internet, also known as “the Internet of Things” or “IoT.” As it is understood, the IoT is a plurality of devices that may share data over a common network. These devices include not only traditional computers, such as desktop and laptop computer, servers, smart phones, tablets, and the like, but also so-called “dumb” devices that have been embedded with a computer-based device with internet communications capability. Such devices include, without limitation, residential appliances and environmental control systems, manufacturing equipment, machinery, sensors, and batteries. Smart devices 111a-h may be equipped with power measuring devices 109, thus obviating the need for a separate measuring device 109. It will be understood, that “smart devices” may include “smart homes” or smart commercial buildings 111h which are provided with computer-based equipment that are able to measure power consumption, and power savings for the entire building. Accordingly, it will be understood, that the term “power consuming devices” may include a smart building

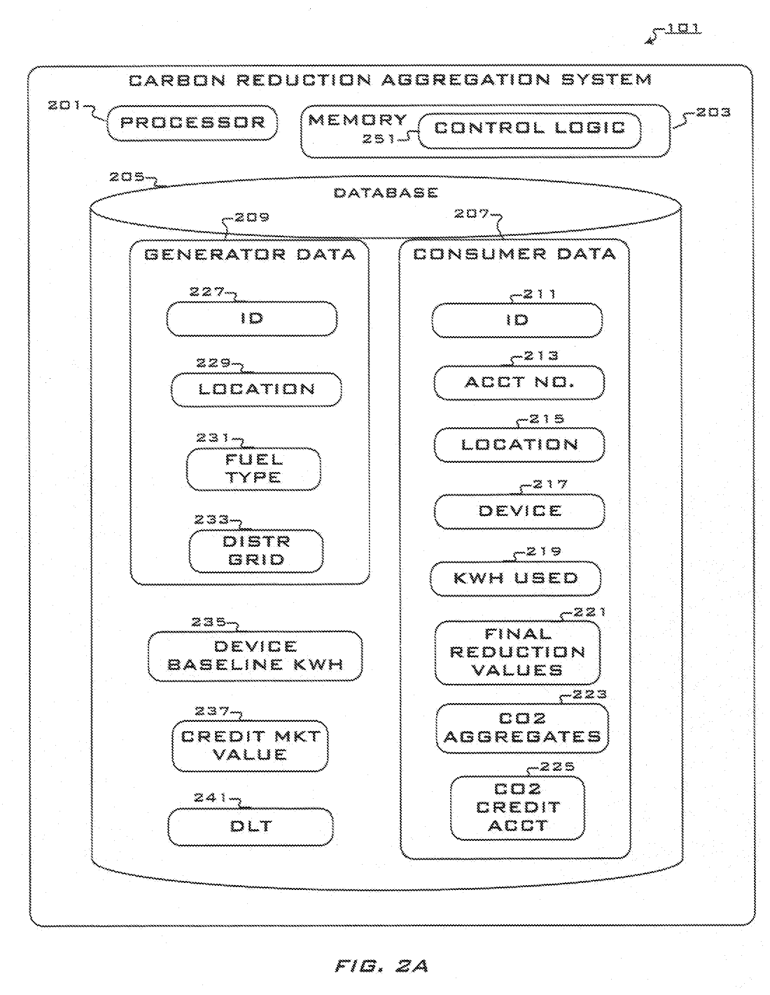

FIGS. 2A & B, are functional block diagrams illustrating an exemplary embodiment of an automated carbon reduction aggregation system (“ACRAS”) 101. The ACRAS 101 comprises a computer-based system with a processor 201 and memory 203, and which may also be a plurality of computer systems communicating via a network 140 (e.g., cloud computing). ACRAS 101 is configured with a database 205 and control logic 251 (described in greater detail below) adapted to perform the functions of the ACRAS 101 described herein. Database 205 may comprise one or more databases, each of which may be one or more text files, relational databases, or any other suitable data structure capable of storing information. Database 205 is configured to store certain data which may comprise consumer data 207 power generator data 209. Consumer data 207 may comprise data representing unique consumer identifying information 211, consumer account number 213, consumer location 215, consumer device used 217, power consumption 219, CO₂ reduction values 221, CO₂ use 223, and consumer CO₂ credit account 225. Generator data 209 may include data representing unique power generator 105 identifying information 227, power generator location data 229, power generator fuel type 231, and the distribution grid location data 233. Database 205 may also include data representing device standard power consumption 235, CO₂ credit market value 237, and distributed ledger database 241.

Processor 201 may include one or more microprocessors, controllers, or any other suitable computing devices or resources. Processor 201 may work, either alone or with components of the ACRAS 101, to provide a portion or all of the functionality of the ACRAS 101 described herein. Processor 201 communicatively couples to memory 203. Memory 203 may take the form of volatile or non-volatile memory including, without limitation, magnetic media, optical media, RAM, ROM, removable media, or any other suitable memory component.

In certain embodiments, memory 203 may be internal or external to processor 201 and may include one or more instruction caches or one or more data caches. Instructions in the instruction caches may be copies of instructions in memory 203, and the instruction caches may speed up retrieval of those instructions by processor 201. Data in the data caches may include any suitable combination of copies of data in memory 203 for instructions executing at processor 201 to operate on, the results of previous instructions executed at processor 201 for access by subsequent instructions executing at processor 201, or for writing to memory 203, and other suitable data. The data caches may speed up read or write operations by processor 201.

As mentioned above, the ACRAS also includes control logic 251 in the form of one or more engines for executing the operations of the ACRAS. These include a CO₂ reduction calculation engine 253, a line loss calculation engine 259, an aggregation engine 261, a CO₂ credit token generation engine 263, a validation engine 265, a distributed ledger generation engine 267, a web interface module 269, a peer-to-peer (“P2P”) module 271 and a CO₂ credit conversion engine 273. As used herein, the term engines may be understood to be any software, hardware, firmware, or combination thereof capable of initiating or performing the functions described. According to some embodiments, engines may be understood to be a set of instructions stored in memory 203 that may be executed by processor 201.

In operation, a power consumer 103 may access ACRAS 101 via web interface 269. In some embodiments, the ACRAS associates a unique consumer identifier which is saved in consumer identification database 211, which may also include the consumer's ACRAS login credentials, and a unique account number with the consumer 103. In another embodiment, consumer 103 may register consumer devices 111a-h and such data is saved in the consumer data database 207 where it is stored as device data 217 and associated with the consumer's unique identifier 211 and account number 213. Once the ACRAS 101 establishes a database record for consumer 103, consumer 103 may interface with the ACRAS 101 through web interface 269 by logging in with login credentials associated with the consumer identifier 211. Thereafter, consumer power consumption data may be provided to the ACRAS 101 via network 140 along data lines 104.

In some embodiments, each device 111a-h, is associated with a separate power measuring device 109, as mentioned above, configured with a network data communications module for transferring data over network 140. In some embodiments, each device 111a-h is a smart device in communication with network 140 via any suitable wired (e.g., ethernet) or wireless protocols such as Bluetooth, near-field communication (“NFC”), WiFi, LiFi, and 3G, or any wireless communication protocol hereafter developed, and may provide data representing energy reduction.

ACRAS 101 may automatically obtain from consumer 103 usage data for each consumer device 111a-h as the consumer 103 energizes those devices. As mentioned above, some embodiments provide consumer devices 111a-h that are each associated with a measuring device 109 which measures the energy consumed by the device 111a-h. In one embodiment, an exemplary measuring device 109 is disclosed in U.S. Pat. No. 9,489,027 to Ogletree, et al., which determines a power profile for a power profile for a computer-based device and then matching that profile to other machines that are similar in configuration. Each tested machine has a power profile that is recorded and saved in cloud-based memory storage. A striated matching methodology is utilized to provide the best profile match for each target machine in the enterprise which allows for accurate power calculations for each machine based upon similar original target machine profiles. Once power calculations are done for target machines based on the established profiles, power schemes are then be deployed across an enterprise computing landscape and power calculations taken again to determine potential power savings. It is contemplated that such devices and methods may be employed where appropriate in the present system to determine power reduction values.

ACRAS 101 obtains the power consumption data 219. CO₂ reduction engine retrieves this power consumption data 219 associated with the consumer from database 219 and consumer device data 217 and generates an initial CO₂ reduction value by calling initial reduction value module 255. In one embodiment, initial reduction value module 255 retrieves the power consumption data 219 from database 207. Next, initial reduction value module 255 calculates the baseline power consumption for the device 111a-h over the same time of usage by accessing the device standard power consumption data 235. The initial reduction value module 255 then compares the power consumption data 219 for the device 111a-h with the device baseline power consumption value 235 and determines the difference resulting in an initial reduction value in KwH for the consumer device 111a-h.

Next, line loss calculation engine 259 obtains consumer location data 215 as well as the location of the power generator 105 providing power to the consumer 103. Power generator 105 location data 229 may be stored in the database 205 and may be retrieved from publicly available geographic information systems (“GIS”). In some embodiments, distribution grid data 233 may also be accessed through GIS. Line loss calculation engine 259 may also obtain GIS data of the distribution grid 233 to plot the distance of transmission lines from the power generator 105 to the consumer 103. From this distance, line loss calculation engine 259, calculates approximate power loss from the generator 105 to the consumer 103 due to line loss. Final reduction value module 237 uses line loss value as a multiplier to calculate a final, refined reduction in KwH used by the device 111a-h. CO₂ conversion engine 273 then obtains this final reduction value and converts it from KwH to a CO₂ reduction value in kg based upon power generator fuel type data 231 associated with the power generator 105 related to the consumer 103. CO₂ calculation reduction engine 253 then populates the final CO₂ reduction value database 221 within the consumer data 207. In some embodiments, measuring device 109 may provide power consumption savings to ACRAS 101. In this case, ACRAS 101 does not compare device 111a-h actual consumption to a device standard consumption. Initial reduction calculation module 255, therefore, simply uses this data as the initial reduction value and a final reduction value is generated as described above. Again, CO₂ conversion engine 273 may simply obtain this final reduction value and convert it to CO₂ reduction value whereupon this data is supplied to the final CO₂ reduction value database 221 under the consumer data 207.

Upon calculation of the final CO₂ reduction value, the ACRAS 101 then calls aggregation engine 261 which sums the individual values final CO₂ reduction value data 221 resulting in an aggregate CO₂ value and this data 223 is also stored in the database 207. In one embodiment, the credit token generation engine 263 is called to monitor a consumer's aggregate CO₂ value data 223 to measure the values against a predetermined threshold. Once this threshold is met, credit token generation engine 263 generates a digital token that represents a CO₂ credit which is stored in the consumer's CO₂ credit account. The threshold value may be any amount deemed marketable. For example, in some embodiments, a digital token may be generated when aggregated carbon credits reach a threshold of 1 ton (907.185 kg) of carbon saved.

Those skilled in the relevant arts will appreciate the above-described system is self-validating. In other words, there is no requirement for a third party such as [ ] to verify carbon credits result from human-implemented carbon reduction practices. There is no human activity that must be verified in order to generate a valid carbon credit that credit redeeming entities may rely upon. Devices 111a-h are essentially self-reporting in that they automatically transmit power saving data. Further, because power generator fuel type and line losses are taken into account, carbon credit redeeming entities may rely upon the accuracy of the carbon credit value.

Once a digital token is generated, the consumer 103 may redeem the token by offering it to a redeeming entity which is any entity interested in purchasing carbon offsets.

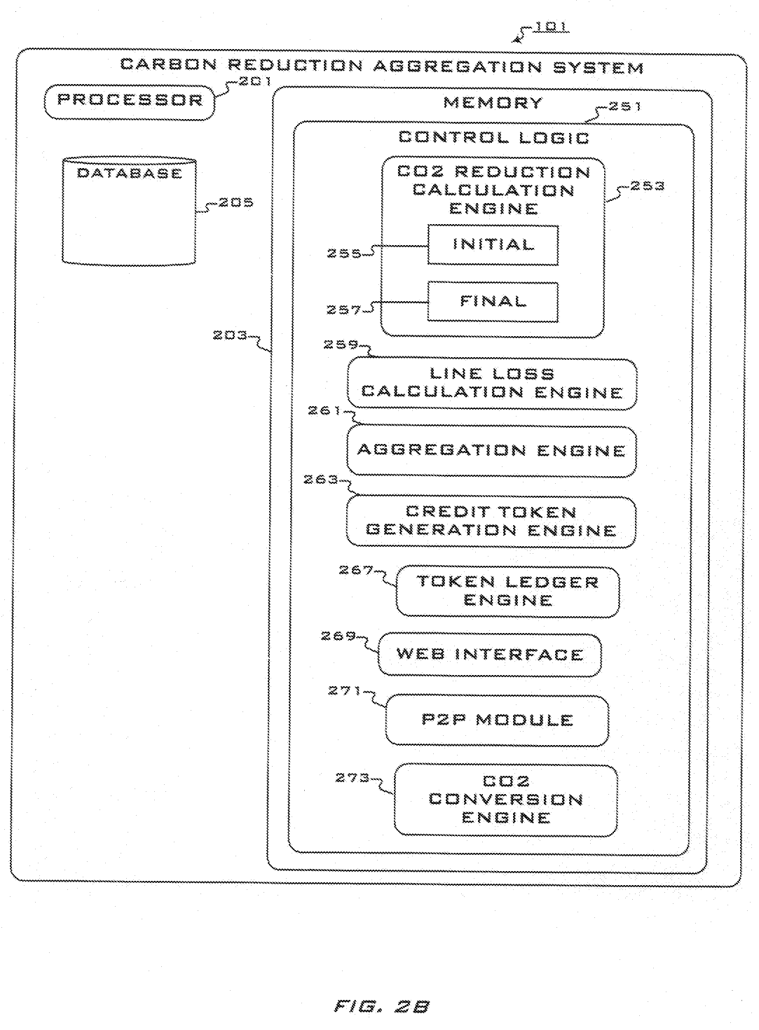

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. Software, or “control logic,” running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer-based systems 300. This disclosure contemplates computer system 300 taking any suitable physical form. For example and not by way of limitation, computer system 300 may be an embedded computer system, a system-on-chip (SOC), a single-board computer system (SBC)(such as, for example, a computer-on-module (COM) or system-on-module (SOM)), appliances, machines, motors, pumps, sensors, a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 3M) may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

Computer system 300 includes a processor 301, memory 303, storage 305, an input/output (WO) interface 307, a communication interface 309, and a bus 311. Although this disclosure describes and illustrates a particular computer system having a particular number of particular components in a particular arrangement, this disclosure contemplates any suitable computer system having any suitable number of any suitable components in any suitable arrangement.

Processor 301 includes hardware for executing instructions, such as those making up a computer program. To execute instructions, processor 301 may retrieve (or fetch) the instructions from an internal register, an internal cache, memory 303, or storage 305; decode and execute them; and then write one or more results to an internal register, an internal cache, memory 303, or storage 305. In particular embodiments, processor 301 may include one or more internal caches for data, instructions, or addresses. This disclosure contemplates processor 301 including any suitable number of any suitable internal caches, where appropriate. Processor 301 may include one or more instruction caches, one or more data caches, and one or more translation lookaside buffers (TLBs). Instructions in the instruction caches may be copies of instructions in memory 303 or storage 305, and the instruction caches may speed up retrieval of those instructions by processor 301. Data in the data caches may be copies of data in memory 303 or storage 305 for instructions executing at processor 301 to operate on; the results of previous instructions executed at processor 301 for access by subsequent instructions executing at processor 301 or for writing to memory 303 or storage 305; or other suitable data. The data caches may speed up read or write operations by processor 301. The TLBs may speed up virtual-address translation for processor 301. In particular embodiments, processor 301 may include one or more internal registers for data, instructions, or addresses. This disclosure contemplates processor 301 including any suitable number of any suitable internal registers, where appropriate. Where appropriate, processor 301 may include one or more arithmetic logic units (ALUs); be a multi-core processor; or include one or more processors 301. Although this disclosure describes and illustrates a particular processor, this disclosure contemplates any suitable processor.

Memory 303 includes main memory for storing instructions for processor 301 to execute or storing data for processor 301 to operate on. Computer system 300 may load instructions from storage 305 or another source (such as, for example, another computer system 300) to memory 303. Processor 301 may then load the instructions from memory 303 to an internal register or internal cache. To execute the instructions, processor 301 may retrieve the instructions from the internal register or internal cache and decode them. During or after execution of the instructions, processor 301 may write one or more results (which may be intermediate or final results) to the internal register or internal cache. Processor 301 may then write one or more of those results to memory 303. In particular embodiments, processor 301 executes only instructions in one or more internal registers or internal caches or in memory 303 (as opposed to storage 305 or elsewhere) and operates only on data in one or more internal registers or internal caches or in memory 303 (as opposed to storage 305 or elsewhere). One or more memory buses (which may each include an address bus and a data bus) may couple processor 301 to memory 303. Bus 311 may include one or more memory buses, as described below. In particular embodiments, one or more memory management units (MMUs) reside between processor 301 and memory 303 and facilitate accesses to memory 303 requested by processor 301. In particular embodiments, memory 303 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 303 may include one or more memories 303, where appropriate. Although this disclosure describes and illustrates particular memory, this disclosure contemplates any suitable memory.

In some embodiments, storage 305 includes mass storage for data or instructions. Storage 305 may include a hard disk drive (HDD), a floppy disk drive, flash memory, an optical disc, a magneto-optical disc, magnetic tape, or a Universal Serial Bus (USB) drive or a combination of two or more of these. Storage 305 may include removable or non-removable (or fixed) media, where appropriate. Storage 305 may be internal or external to computer system 300, where appropriate. In particular embodiments, storage 305 is non-volatile, solid-state memory. Storage 305 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 305 taking any suitable physical form and may include one or more storage control units facilitating communication between processor 301 and storage 305, where appropriate. Where appropriate, storage 305 may include one or more storages 305.

I/O interface 307 includes hardware, software, or both, providing one or more interfaces for communication between computer system 300 and one or more I/O devices. Computer system 300 may include one or more of these I/O devices. One or more of these I/O devices may enable communication between a person and computer system 300. For example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 307 for them. Where appropriate, I/O interface 307 may include one or more device or software drivers enabling processor 301 to drive one or more of these I/O devices. I/O interface 307 may include one or more V/O interfaces 307, where appropriate.

Communication interface 309 includes hardware, software, or both providing one or more interfaces for communication (such as, for example, packet-based communication) between computer system 300 and one or more other computer systems 300 or one or more networks. Communication interface 309 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 309 for it. Computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. For example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 309 for any of these networks, where appropriate. Communication interface 309 may include one or more communication interfaces 309, where appropriate. Although this disclosure describes and illustrates a particular communication interface, this disclosure contemplates any suitable communication interface.

Bus 311 includes hardware, software, or both coupling components of computer system 300 to each other. Bus 311 may include an Accelerated Graphics Port (AGP) or other graphics bus, an Enhanced Industry Standard Architecture (EISA) bus, a front-side bus (FSB), a HYPERTRANSPORT (HT) interconnect, an industry Standard Architecture (ISA) bus, an INFINIBAND interconnect, a low-pin-count (LPC) bus, a memory bus, a Micro Channel Architecture (MCA) bus, a Peripheral Component Interconnect (PC) bus, a PCI-Express (PCIe) bus, a serial advanced technology attachment (SATA) bus, a Video Electronics Standards Association local (VLB) bus, or another suitable bus or a combination of two or more of these. Bus 311 may include one or more buses 311, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives. SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

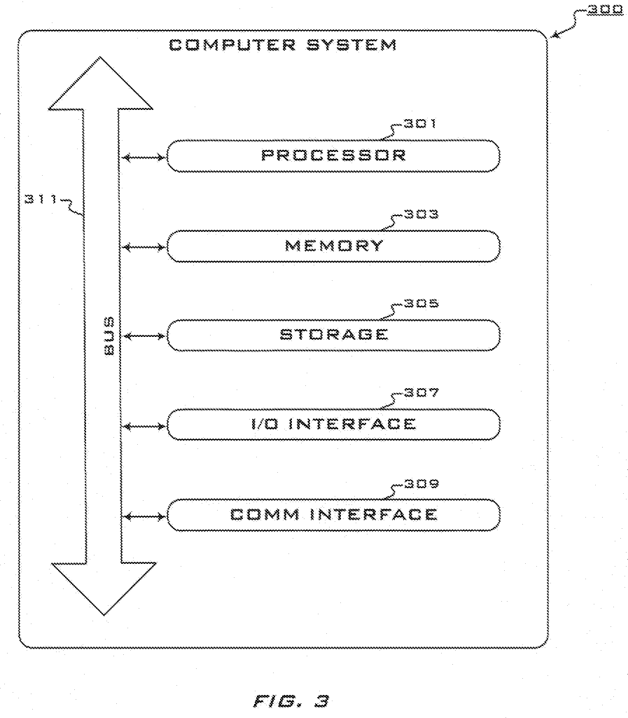

A flowchart for the process 400 performed by the system described above is shown in FIG. 4 where, after start 401, user power consumption is obtained from measuring device 109 or from a smart device 111a-h where applicable. In addition, in steps 402 and 403, the locations of the consumer 103 and the consumer's power generator 105 are obtained. This may be done, in some embodiments, where the consumer registers with the ACRAS before consumer power consumption is obtained. When the power generator 105 is provided, the system also assigns the relevant power generation fuel type at step 405.

Next, at step 406 the system determines whether it has been provided energy reduction values from a smart device. Where the device simply provides power consumption for a device, the ACRAS queries the usual power consumption rate for that device and compares it to the power consumption data obtained from the user device 111 for the same duration of usage at step 407. From this an initial energy reduction value is determined, step 408. Where a smart device automatically transmits energy reduction data, indicated by “Y” at the decision block of 406, the ACRAS uses this data as the initial reduction value at step 408.

Next, in some embodiments, this initial value is converted to a CO₂ reduction value in kg at step 409 and meanwhile line loss between the power generator location and the consumer location is determined 410. This line loss value may be then converted to CO₂ reduction at step 411 whereupon a final reduction value in CO₂ is determined at step 412. However, it will be understood that steps 409 through 412 may be performed in another order. For example, the ACRAS may be configured to calculate the final reduction value (step 412) in KwH before converting it to a CO₂ value in kg. Further, step 410 for calculating line loss may be performed concurrently with step 408. At step 413 the final reduction amounts per device are aggregated for the consumer and when the aggregate value reaches a pre-determined threshold value, a carbon credit token is generated representing that value at step 414.

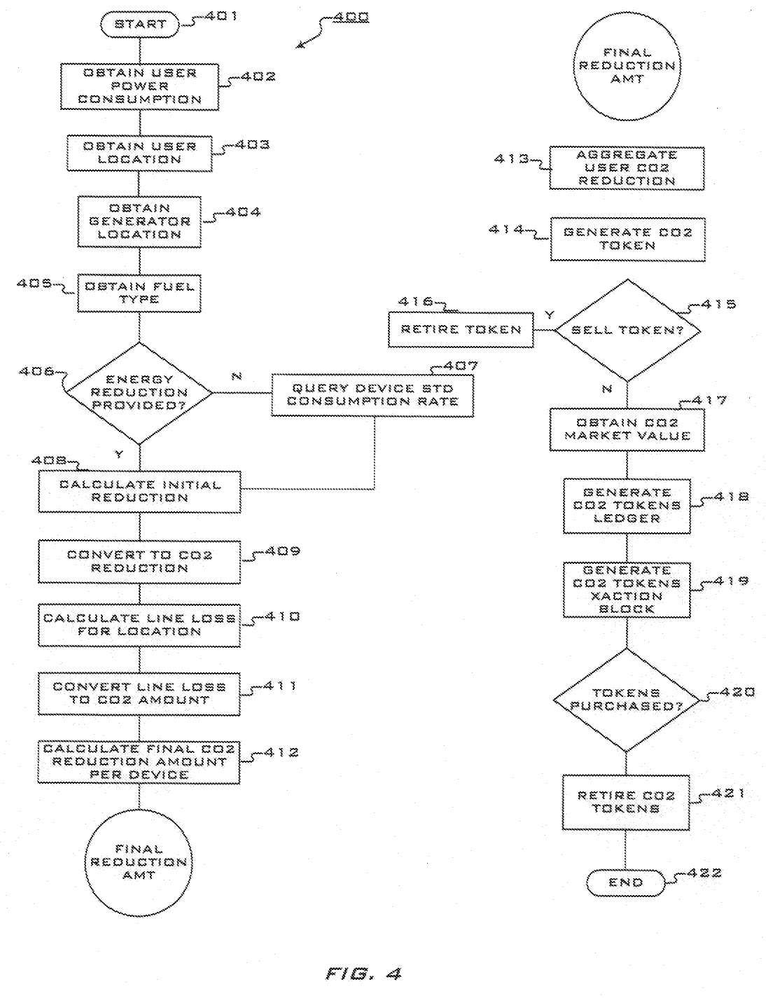

At decision point 415, if the token is sold to a third-party buyer, the token in retired 416. If the token is not sold, a current market value for the amount of CO₂ represented by the token is obtained from a third-party database 417 and then a distributed ledger is generated 418. A distributed ledger transaction block is then generated 419. When a token is purchased 420, the purchased token is retired. A non-limiting example of an electronic token transaction block 501 is shown in FIG. 5, wherein the token 501 may comprise a unique token identification code 503, a time stamp 505 of when the transaction block 501 was created, the token owner identification code 507 and the CO₂ amount represented by the token 501.

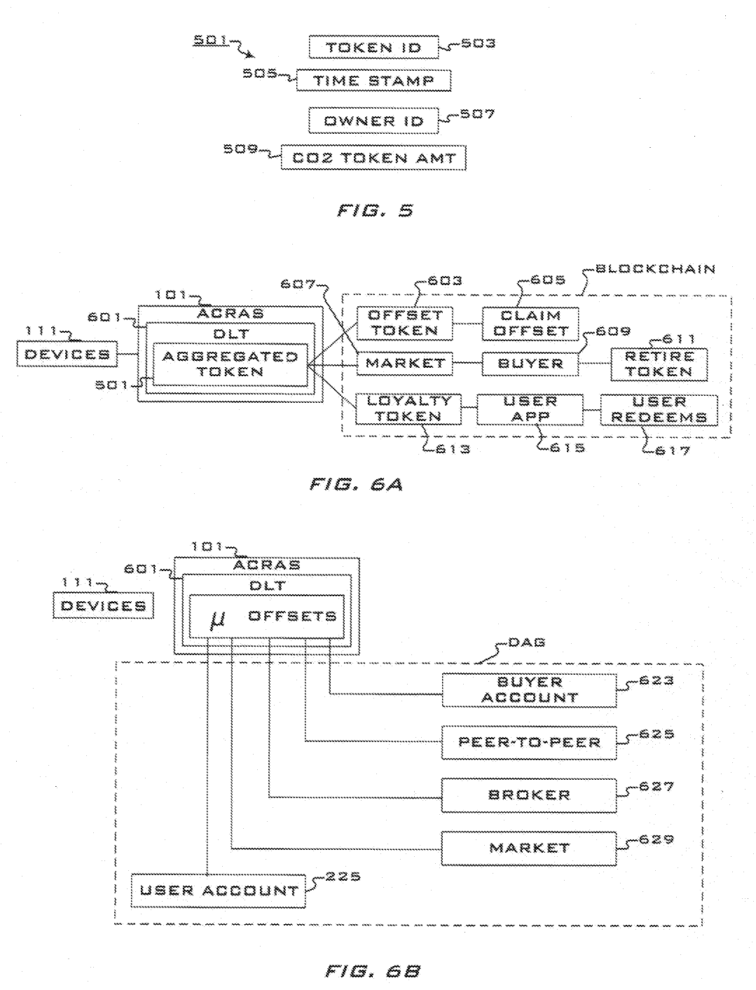

Moving to FIG. 6A, a functional block diagram illustrates a further embodiment of a system configured to perform an embodiment of the exemplary processes set forth. As described above, energy consuming devices 111 (or power measuring devices 109) provide energy reduction data to the ACRAS 101 wherein CO₂ offsets are calculated to the final reduction value. For the case in which the ACRAS 101 generates an aggregated token 501, a distributed ledger 601 may be created by the ACRAS 101 for transacting the token 501 via a blockchain. Where an entity that desires to accumulate carbon offsets, such an entity may directly purchase a token 501 which would be used for such an offset. Alternatively, the token may be made available via blockchain to a carbon market 607 where a buyer 609 may purchase the token. Thereafter, the token is retired 611. Finally, the token 501 may be used as a loyalty reward that a user may redeem 617 via an app 615.

Yet another embodiment is shown in FIG. 68. In this example, the ACRAS 101 calculates micro offsets 621, each of which are comprised in a distributed ledger 601. This ledger provides the basis for a directed acyclic graph (“DAG”). Micro offsets 621, which may be thought of as micro transactions, are distributed via a DAG to one or more of a buyer account 623, another entity 625 via a peer-to-peer transfer, a carbon broker 627 and a carbon market 629. In each of these transfers, the micro offsets 621 are accumulated by the entities to which the micro offsets are transferred. In the alternative, the micro offsets 621 may be transferred to the user account 225 via a DAG. The micro offsets 621 accumulate in the user account 225 until the cumulative value of the micro offsets reach a marketable amount.

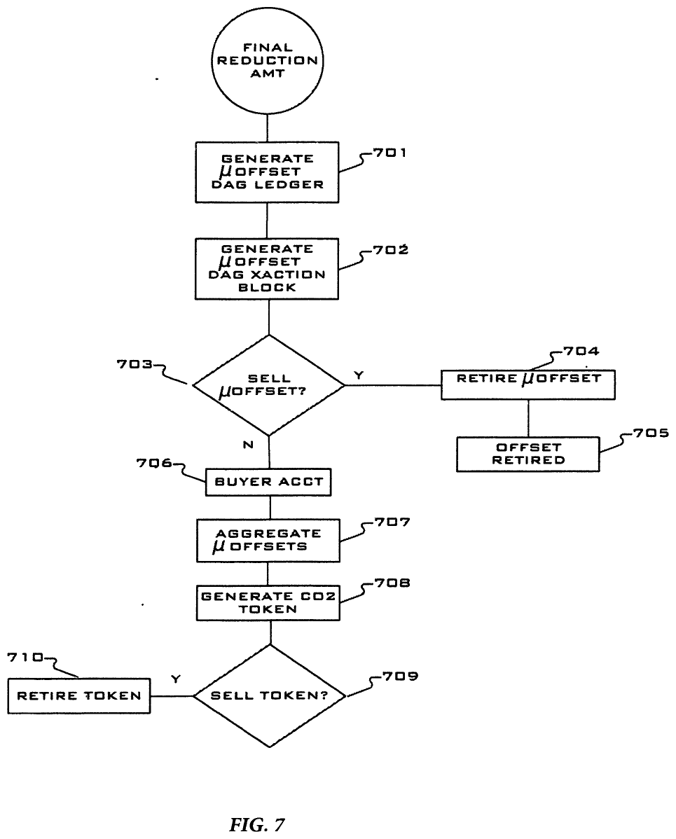

FIG. 7 is a flowchart depicting a process 700 performed by the system described with respect to FIG. 68. A final reduction amount for a micro offset is obtained via the process shown in FIG. 4 up to step 412. A distributed ledger is generated, preferably a DAG. 701. A DAG transaction block is then generated for the micro offset 702 establishing a value equal to the final reduction value. If the micro offset is transferred at decision point 703 via the distributed ledger via directed acyclic graph, the micro offset is accumulated by buyer 704 and is eventually retired when the micro offset is sold 705. If the micro offset is not transferred to a third-party entity, micro offsets are transferred via distributed ledger to the user's account 706 where it is accumulated with all user micro offsets 707 until the amount of offsets reaches a marketable amount and a token is generated 708. If the user sells or redeems the token whereupon the token is retired 710.

As described above and shown in the associated drawings, the present invention comprises a method and system for automated aggregation of carbon offsets. While particular embodiments have been described, it will be understood, however, that any invention appertaining to the method and system described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A method, executed by one or more computers, for automatically measuring carbon offsets for one or more devices consuming electrical power, said devices used by a user, said method comprising the steps of:
obtaining power usage data in kilowatt-hours from said one or more electrically-powered devices;
calculating an initial power reduction value based upon said power usage data;
calculating a final reduction value by applying a line loss multiplier to said initial reduction value, said line loss multiplier accounting for power loss over a distance between a power generator and said one or more devices;
calculating a carbon offset amount by converting said final reduction value from kilowatt-hours to a mass of carbon dioxide saved based upon a fuel type used to generate said electrical power; and
associating said carbon offset amount to said user.

2. The method of claim 1, wherein said step of calculating a final reduction value further comprises the steps of:
obtaining a geographic location for said user; and
obtaining a geographic location for said power generator.

3. The method of claim 1, further comprising the steps of:
aggregating all carbon offsets associated with said user;
generating a carbon offset token when a total of aggregated carbon offsets reaches a pre-determined amount; and
associating said carbon offset token with said user

4. The method of claim 3, further comprising the step of:
generating distributed ledger for accounting for said aggregated carbon offsets.

5. The method of claim 1, wherein said step of calculating said initial reduction value comprises the steps of:
determining a baseline power usage for said one or more devices; and
comparing said power usage data to said baseline power usage.

6. The method of claim 5, wherein said step of calculating a final reduction value further comprises the steps of:
obtaining a geographic location for said user; and
obtaining a geographic location for said power generator.

7. The method of claim 6, further comprising the steps of:
aggregating all carbon offsets associated with said user;
generating a carbon offset token when a total of aggregated carbon offsets reaches a pre-determined amount; and
associating said carbon offset token with said user

8. The method of claim 7, further comprising the step of:
generating distributed ledger for accounting for said aggregated carbon offsets.

9. The method of claim 1, further comprising the steps of:
generating a distributed ledger for accounting for said carbon offsets; and
aggregating said carbon offsets associated with said user via said distributed ledger.

10. The method of claim 9, wherein said step of calculating said initial reduction value comprises the steps of:
determining a baseline power usage for said one or more devices; and
comparing said power usage data to said baseline power usage.

11. The method of claim 11, wherein said step of calculating a final reduction value further comprises the steps of:
obtaining a geographic location for said user; and
obtaining a geographic location for said power generator.

12. A system for automatically measuring carbon offsets for one or more devices consuming electrical power, said devices used by a user, said system comprising:
a processor;
a computer-readable memory in communication with said processor, said memory configured to store control logic and data, said data comprising:
said user's location;
said user's one or more devices;
the location of a power generator associated with said user;
a fuel type used by said power generator; and
a distributed ledger; and
a network interface in communication in communication with said one or more devices; and
wherein, said control logic causes said processor to:
obtain power usage data in kilowatt-hours from said one or more devices;
calculate an initial power reduction value based upon said power usage data;
calculate a final reduction value by applying a line loss multiplier to said initial reduction value, said line loss multiplier accounting for power loss over a distance between a power generator and said one or more devices;
calculate a carbon offset amount by converting said final reduction value from kilowatt-hours to a mass of carbon dioxide saved based upon said fuel type used to generate said electrical power; and
associate said carbon offset amount to said user.

13. The system of claim 12, wherein said control logic further causes said processor to:
aggregate all carbon offsets associated with said user;
generate a carbon offset token when a total of aggregated carbon offsets reaches a pre-determined amount; and
associate said carbon offset token with said user.

14. The system of claim 13, wherein said control logic further causes said processor to:
generate said distributed ledger for accounting for said carbon offset token.

15. The system of claim 12, wherein said control logic further causes said processor to:
generate said distributed ledger for accounting for said carbon offsets.
